(19) United States
(12) Patent Application Publication
(10) Pub. No.: US 2024/0402457 A1
(43) Pub. Date: Dec. 5, 2024

(54) OPTICAL ELEMENT DRIVING MECHANISM

(71) Applicant: TDK TAIWAN CORP., Taoyuan City (TW)

(72) Inventors: Chen-Hung CHAO, Taoyuan City (TW); Po-Xiang ZHUANG, Taoyuan City (TW); Yi-Ho CHEN, Taoyuan City (TW); Wei-Jhe SHEN, Taoyuan City (TW); Sin-Jhong SONG, Taoyuan City (TW)

(21) Appl. No.: 18/679,006

(22) Filed: May 30, 2024

Related U.S. Application Data
(60) Provisional application No. 63/469,676, filed on May 30, 2023.

(51) Int. Cl. G02B 7/08

(52) U.S. Cl. CPC G02B 7/08

(57) ABSTRACT

An optical element driving mechanism is provided. The optical element driving mechanism includes a fixed portion, a movable portion, and a driving component. The movable portion is configured to connect an optical element. The optical element has an optical axis. The movable portion is movable relative to the fixed portion. The driving component is configured to drive the movable portion to move relative to the fixed portion.

### CROSS REFERENCE TO RELATED APPLICATIONS

This application claims the benefit of U.S. Provisional Application No. 63/469,676, filed on May 30, 2023, the entirety of which is incorporated by reference herein.

### BACKGROUND OF THE INVENTION

### Field of the Invention

The present invention relates to an optical element driving mechanism, and in particular to an optical element driving mechanism with an integrated base.

### Description of the Related Art

With the advancement of technology, many electronic devices today (such as smartphones or digital cameras) are equipped with photo or video recording functions. The use of these electronic devices is becoming increasingly common, and they are being developed with more convenient and lightweight designs to offer users more choice.

The aforementioned electronic devices with photo or video recording functions are usually equipped with an optical element driving mechanism, allowing light to pass through the optical elements (such as shutter blades, filters, lenses, etc.) to form an image on the image sensor. The current trend in mobile devices is to reduce costs while increasing durability, making it an important issue to effectively simplify complex assembly stations and enhance durability.

### BRIEF SUMMARY OF THE INVENTION

The present disclosure provides an optical element driving mechanism, including a fixed portion, a movable portion, and a driving component. The movable portion is configured to connect an optical element. The optical element has an optical axis. The movable portion is movable relative to the fixed portion. The driving component is configured to drive the movable portion to move relative to the fixed portion.

According to some embodiments of the present disclosure, the fixed portion includes a base. The base includes a body. The body includes an annular portion and a pair of protruding columns. The structure of the annular portion is perpendicular to the optical axis. The pair of protruding portions extend from the annular portion in a direction that is parallel to the optical axis on one side of the annular portion.

According to some embodiments of the present disclosure, the base further includes a retaining wall and a connecting element. The retaining wall is parallel to the optical axis. The retaining wall is located between this pair of protruding columns. The connecting element is partially embedded in the annular portion, the retaining wall and the pair of protruding columns.

According to some embodiments of the present disclosure, the retaining wall of the base includes a contact portion, a pair of front surfaces, and a protruding portion. The contact portion is the surface of the retaining wall that is facing the optical axis. The pair of front surfaces are the surfaces of the retaining wall that are facing away from the optical axis. The protruding portion protrudes from between the pair of front surfaces in the direction away from the optical axis.

According to some embodiments of the present disclosure, the driving component includes a coil and two magnetically permeable elements. The coil is disposed on the contact portion of the retaining wall. The magnetically permeable elements are respectively disposed on the pair of front surfaces of the retaining wall. The magnetically permeable elements contact opposite sides of the protruding portion to position the magnetically permeable elements.

According to some embodiments of the present disclosure, the fixed portion further includes a frame. The frame includes a recessed surface, a lower surface and an accommodating space. The recessed surface and the lower surface are planes of the frame that are perpendicular to the optical axis. The recessed surface and the lower surface have different heights on the optical axis. A space for accommodating retaining walls and the pair of protruding columns is formed between the recessed surface and the lower surface. The upper surface of the retaining wall is affixed to the recessed surface of the frame to secure the retaining wall.

According to some embodiments of the present disclosure, the optical element driving mechanism further includes an elastic element. The fixed portion includes a base. The elastic element includes a fixed end, a connecting end and an elastic portion. The base includes a bottom surface and a welding portion. The welding portion of the base is a structure recessed from the bottom surface in a direction that is parallel to the optical axis. The welding portion corresponds to the fixed end of the elastic element. The fixed end of the elastic element is disposed on the bottom surface of the base. The welding portion of the base and the fixed end of the elastic element securely connect the base and the elastic element together via welding. The connecting end of the elastic element is configured to be fixedly connected to an optical module. The elastic portion of the elastic element is made of elastic material. Two ends of the elastic portion are respectively connected to the fixed end and the connecting end.

According to some embodiments of the present disclosure, the base further includes a connecting portion protruding from the bottom surface of the base along the direction of the optical axis. The connecting portion of the base is connected to the optical module located under the optical element driving mechanism.

According to some embodiments of the present disclosure, the optical element driving mechanism further includes a plurality of supporting elements. The fixed portion includes a groove. Two of the supporting elements are disposed in the groove of the fixed portion in a direction that is parallel to the optical axis, and the supporting elements contact the movable portion to provide support for the movement of the movable portion relative to the fixed portion.

According to some embodiments of the present disclosure, the fixed portion includes a frame and a base. The frame includes a body and a structural strengthening element. The structural strengthening element of the frame is partially embedded in the body of the frame. The base includes a body and a structural strengthening element. The structural strengthening element of the base is partially embedded in the body of the base. The structural strengthening element of the frame and the structural strengthening element of the base are joined by welding to securely connect the frame and the base together.

### BRIEF DESCRIPTION OF THE DRAWINGS

Embodiments of the present disclosure is described in detail below with reference to the accompanying drawings. It should be noted that, according to industry standards, various features are not drawn to scale and are for illustrative purposes only. In fact, the sizes of the components may be arbitrarily enlarged or reduced to clearly demonstrate the features of this disclosure.

FIG. 1 is a perspective view of an optical element driving mechanism according to some embodiments of the present disclosure.

FIG. 2 is an exploded view of the optical element driving mechanism according to some embodiments of the present disclosure.

FIG. 3A is a perspective view of an optical element driving mechanism according to some embodiments of the present disclosure, in which an upper cover of a fixed portion is not shown for illustrative purposes.

FIG. 3B is a perspective view of a frame of the fixed portion according to some embodiments of the present disclosure.

FIG. 3C is a partial schematic diagram of a frame according to some embodiments of the present disclosure.

FIG. 4 is a perspective view of a base according to some embodiments of the present disclosure.

FIG. 5A and FIG. 5B show schematic diagrams of the manufacturing process of the base according to some embodiments of the present disclosure.

FIG. 6 shows a partial enlarged view of the optical element driving mechanism according to some embodiments of the present disclosure.

FIG. 7 shows a top view of the base and a coil according to some embodiments of the present disclosure.

FIG. 8 shows a side view of the optical element driving mechanism according to some embodiments of the present disclosure.

FIG. 9 shows a bottom view of the base and an elastic element according to some embodiments of the present disclosure.

### DETAILED DESCRIPTION OF THE INVENTION

Unless otherwise defined, all terms used herein (including technical and scientific terms) have the same meaning as commonly understood by one of ordinary skill in the art to which this disclosure belongs. It is understood that these terms, for example, those defined in commonly used dictionaries, should be interpreted as having a meaning consistent with their meaning in the context of the relevant art and this disclosure, and should not be interpreted in an idealized or overly formal manner unless specifically defined herein.

Furthermore, the use of ordinal numbers such as “first” and “second” in the specification and claims to modify claim elements does not imply any prior sequence of the claim elements, nor does it imply any order of one claim element relative to another or any order in the manufacturing process. The use of such ordinal numbers is solely for the purpose of clearly distinguishing one claim element having a certain designation from another claim element having the same designation.

Additionally, in some embodiments of this disclosure, terms related to joining or connecting, such as “connected” or “interconnected,” unless specifically defined otherwise, can refer to two structures being in direct contact or not in direct contact, with other structures positioned between these two structures. Furthermore, these terms can also include situations where both structures are movable or both structures are fixed.

The present disclosure provides an optical element driving mechanism for driving an optical element. The optical element driving mechanism may drive the optical element (e.g., shutter blade) to a desired position to control the amount of light entering an optical module (not shown). The structure of the optical element driving mechanism is described in detail below.

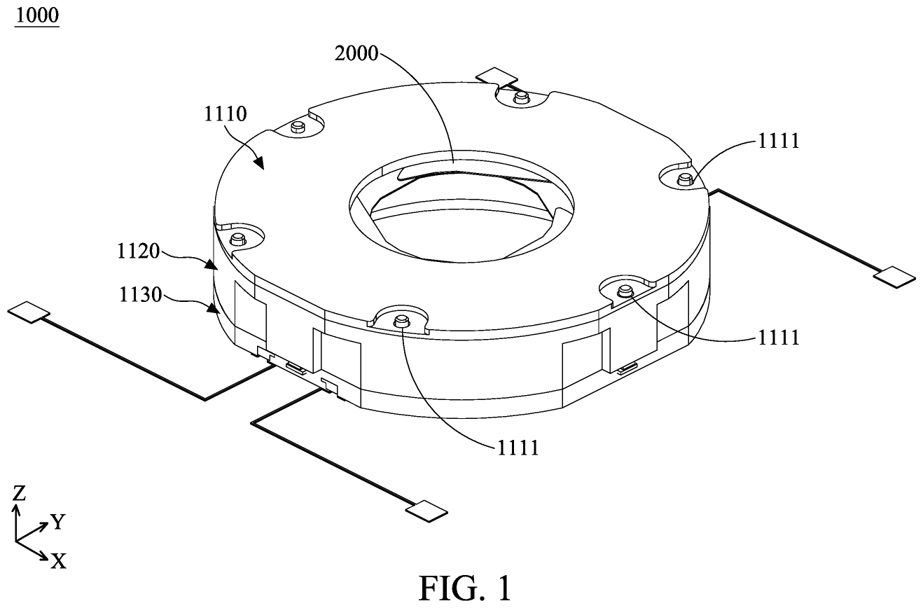

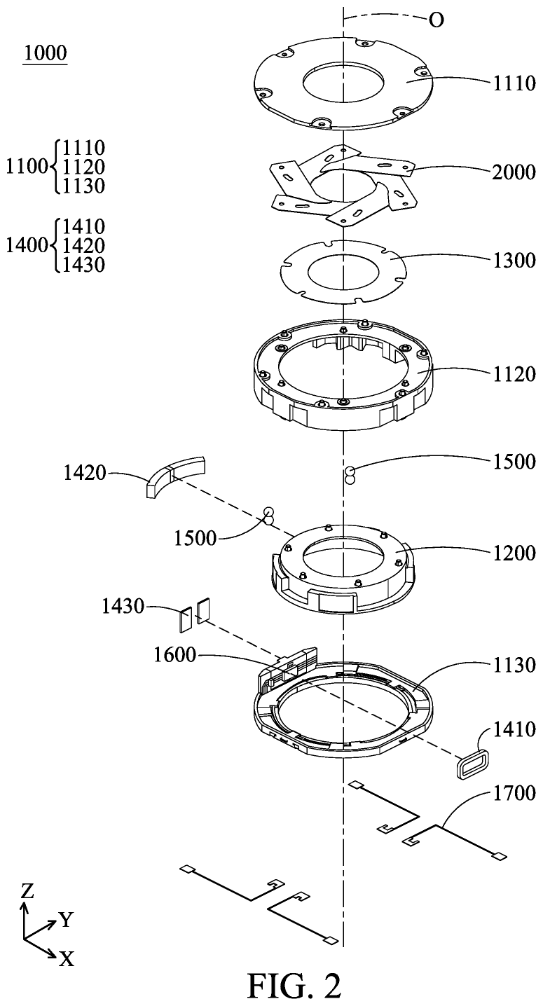

FIG. 1 is a perspective view of an optical element driving mechanism 1000 according to some embodiments of the present disclosure. FIG. 2 is an exploded view of the optical element driving mechanism 1000 according to some embodiments of the present disclosure. As shown in FIG. 1, when viewed along the Z-axis, the optical element driving mechanism 1000 has a substantially circular shape. Please refer to FIG. 1 and FIG. 2 below.

As shown in FIG. 1 and FIG. 2, the optical element driving mechanism 1000 includes a fixed portion 1100, a movable portion 1200, a light shielding element 1300, a driving component 1400, a set of supporting elements 1500, an integrated circuit 1600 and a set of elastic elements 1700.

According to some embodiments of the present disclosure, the fixed portion 1100 includes an upper cover 1110, a frame 1120 and a base 1130. The upper cover 1110 is fixedly connected to the frame 1120, and the frame 1120 is fixedly connected to the base 1130 to form a space for accommodating other components in the optical element driving mechanism 1000.

According to some embodiments of the present disclosure, the movable portion 1200 is movable relative to the fixed portion 1100. The optical element 2000 is connected to the frame 1120 and the movable portion 1200, and is driven by the movable portion 1200 to move to a desired position relative to the fixed portion 1100, thereby adjusting the amount of light entering the optical element driving mechanism 1000. According to some embodiments of the present disclosure, the light-shielding element 1300 (e.g., SOMA) is disposed on the movable portion 1200 to effectively suppress stray light and improve image quality.

According to some embodiments of the present disclosure, the driving component 1400 is configured to drive the movable portion 1200 to move relative to the fixed portion 1100. The driving component 1400 includes a coil 1410, a set of magnetic elements 1420 and two magnetically permeable elements 1430. The coil 1410 is disposed on base 1130. The magnetic element 1420 is disposed on the movable portion 1200. The magnetically permeable element 1430 is disposed on the base 1130.

According to some embodiments of the present disclosure, the coil 1410 and the magnetic element 1420 correspond to each other. Specifically, when a driving signal is applied to the driving component 1400 (for example, a current is applied by an external power supply), an electromagnetic induction force is generated between the coil 1410 and the magnetic element 1420, thereby driving the movable portion 1200 to move relative to the fixed portion 1100 to achieve the desired optical effect.

According to some embodiments of the present disclosure, the support element 1500 is disposed on the frame 1120 of the fixed portion 1100 and contacts the movable portion 1200 to provide support for the movement of the movable portion 1200 relative to the fixed portion 1100 and to enable smoother movement of the movable portion 1200 relative to the fixed portion 1100.

According to some embodiments of the present disclosure, there is an attractive force between the magnetically permeable element 1430 provided on the base 1130 and the magnetic element 1420 provided on the movable portion 1200. This attractive force causes the movable portion 1200 to rest against the support provided by the supporting element 1500, preventing the movable portion 1200 from wobbling within the fixed portion 1100 due to external forces.

According to some embodiments of the present disclosure, the integrated circuit 1600 is disposed on base 1130. The integrated circuit 1600 is electrically connected to the coil 1410 of the driving component 1400. In some embodiments, the integrated circuit 1600 has the functions of controlling the driving component 1400, while sensing the position of the movable portion 1200 relative to the fixed portion 1100.

According to some embodiments of the present disclosure, the elastic element 1700 is connected to the underside of the base 1130 of the fixed portion 1100 via welding to connect the optical element driving mechanism 1000 to an optical module (not shown) provided with lenses or lens modules. Since the elastic element 1700 has elastic properties, using the elastic element 1700 to connect the optical element driving mechanism 1000 and the optical module (not shown) improves the overall impact resistance.

In other words, when the optical element driving mechanism 1000 and the optical module (not shown) are impacted, since the elastic element 1700 connecting the two has elastic properties, the two are less likely to be separated and disintegrated due to collision.

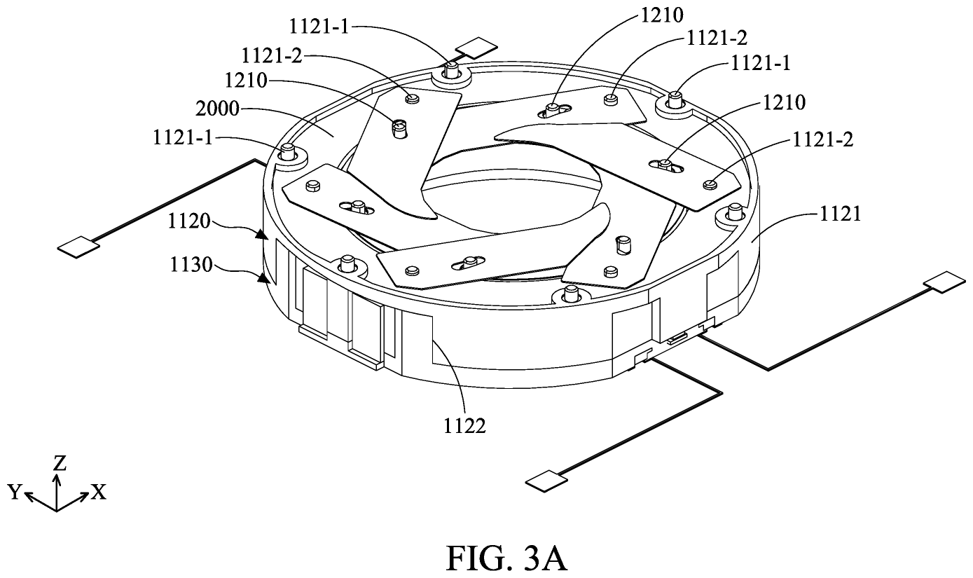

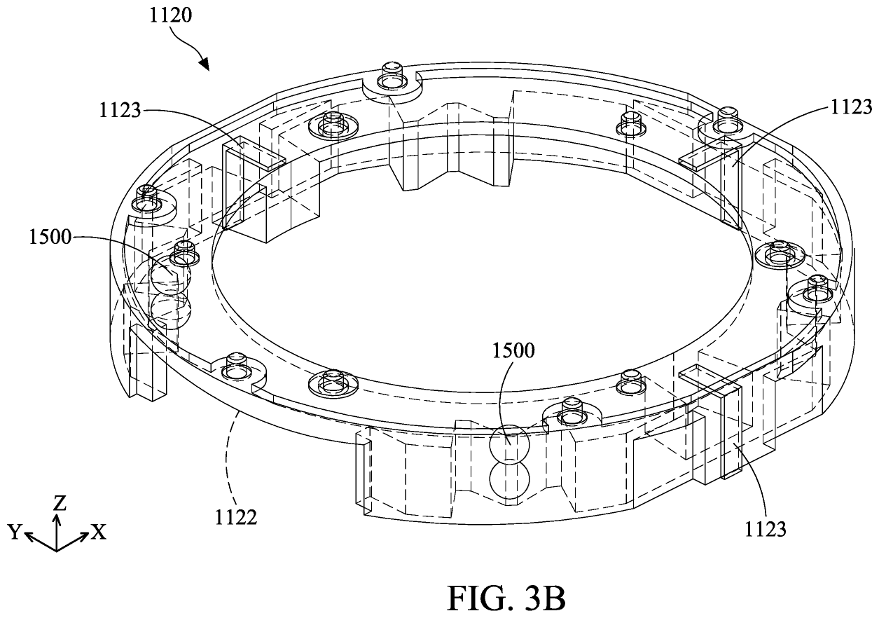

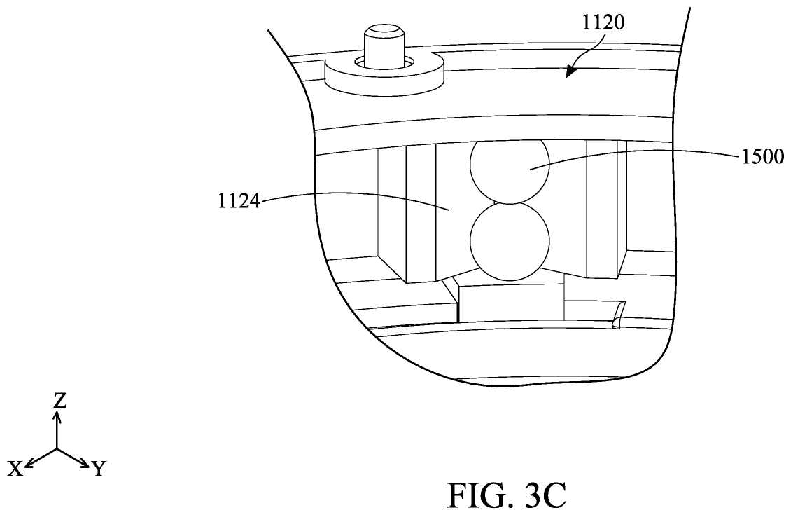

FIG. 3A is a perspective view of the optical element driving mechanism 1000 according to some embodiments of the present disclosure, in which the upper cover 1110 of the fixed portion 1100 is not shown for illustrative purposes. FIG. 3B is a perspective view of the frame 1120 of the fixed portion 1100 according to some embodiments of the present disclosure. FIG. 3C is a partial schematic diagram of a frame 1120 according to some embodiments of the present disclosure.

Please refer to FIGS. 3A to 3C together. The frame 1120 includes a body 1121 (FIG. 3A), an accommodating space 1122 (FIG. 3A), a plurality of structural strengthening elements 1123 (FIG. 3B) and a pair of grooves 1124 (FIG. 3C shows one of the grooves 1124).

As shown in FIG. 3A, the body 1121 of the frame 1120 may be made of plastic or other materials. The body 1121 of the frame 1120 includes a plurality of fixing elements 1121-1 and a plurality of fixed ends 1121-2. The movable portion 1200 includes a plurality of fixed ends 1210. A plurality of fixing elements 1121-1 of the frame 1120 protrude from the top of the body 1121 along the direction of the Z-axis (the direction parallel to the optical axis O).

Please temporarily refer to FIG. 1 and FIG. 3A together. As shown in FIG. 1, the upper cover 1110 includes a plurality of openings 1111. The fixing elements 1121-1 (FIG. 3A) of the frame 1120 pass through the openings 1111 (FIG. 1) of the upper cover 1110. In this way, the upper cover 1110 and the frame 1120 may be firmly fixed together through riveting, plastic welding, etc.

Please refer back to FIG. 3A. The fixed end 1121-2 of the frame 1120 protrudes from the top of the body 1121 along the direction of the Z-axis (the direction parallel to the optical axis O). The fixed end 1210 of the movable portion 1200 protrudes from the top surface of the movable portion along the direction of the Z-axis (the direction parallel to the optical axis O).

As shown in FIG. 3A, each fixed end 1121-2 of frame 1120 and each fixed end 1210 of movable portion 1200 pass through each optical element 2000 provided on the frame 1120 and the movable portion 1200. In this way, when the driving component 1400 (FIG. 2) drives the movable portion 1200 to move relative to the fixed portion 1100, the movable portion 1200 may drive the optical element 2000 to move relative to the fixed portion 1100.

As shown in FIG. 3A, the accommodating space 1122 of the frame 1120 is a notch on one side of the frame 1120, which accommodates the portion of the base 1130 that protrudes upward (toward the direction of the Z-axis), the details of which is described in detail later. In FIG. 3B, for illustrative purposes, the parts of the body 1121 that are not visible in this viewing angle are shown with dash lines.

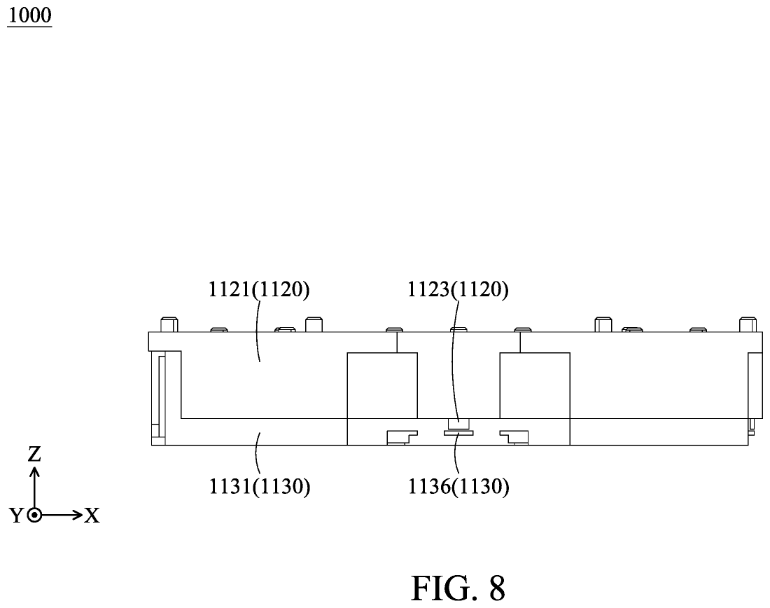

As shown in FIG. 3B, the structural strengthening element 1123 is a metal piece embedded in the body 1121. The structural strengthening element 1123 is only partially exposed from the bottom of the body 1121 of the frame 1120, and is configured to firmly connect the frame 1120 to the base 1130. (FIG. 2), the details of which is explained later in relation to FIG. 8.

As shown in FIG. 3C, in some embodiments of the present disclosure, a set of support elements 1500 is four balls, divided into two groups and respectively disposed in two grooves 1124 of the frame 1120, with each groove accommodating two balls. As shown in FIG. 3C, the two support elements 1500 are arranged along the direction of the Z-axis (parallel to the optical axis O). In this way, the configuration of multi-ball support may reduce the risk of overturning of the movable portion 1200, thereby extending the product lifespan.

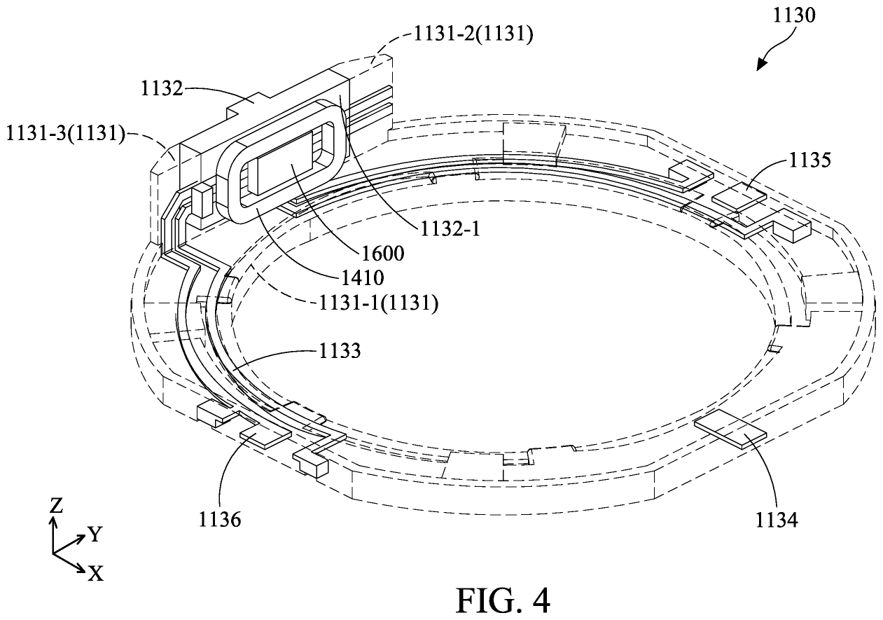

FIG. 4 is a perspective view of the base 1130 according to some embodiments of the present disclosure. As shown in FIG. 4, the base 1130 includes a body 1131, a retaining wall 1132, a plurality of connecting elements 1133 and three structural strengthening elements 1134, 1135, 1136.

In FIG. 4, for illustrative purposes, the body 1131 of the base 1130 is shown with a dash line. As shown in FIG. 4, the body 1131 of the base 1130 may be generally divided into two parts, one of which is an annular portion 1131-1 whose structure is parallel to the XY plane, and the other part is a portion extending along the Z-axis on one side of the annular portion 1131-1. Specifically, these are protruding columns 1131-2 and 1131-3 standing on opposite sides of the retaining wall 1132.

As shown in FIG. 4, the connecting element 1133 and the structural strengthening element 1134 of the base 1130 are metal parts embedded in the body 1131. The connecting element 1133 of the base 1130 is partially embedded in the annular portion 1131-1, the retaining wall 1132 and the protruding columns 1131-2 and 1131-3. Three structural strengthening elements 1134, 1135, 1136 are embedded in the annular portion 1131-1 of the body 1131.

In some embodiments of the present disclosure, the structural strengthening element 1134 is disposed on the opposite side of the body 1131 from the retaining wall 1132 on the XY plane. The structural strengthening elements 1135, 1136 are disposed on the opposite sides of the body 1131, so that the retaining wall 1132 and structural strengthening elements 1134, 1135, 1136 are respectively located at four opposite corners of the base 1130. As shown in FIG. 4, the integrated circuit 1600 and the coil 1410 are disposed on the side of the retaining wall 1132 that is facing the optical axis O (FIG. 2).

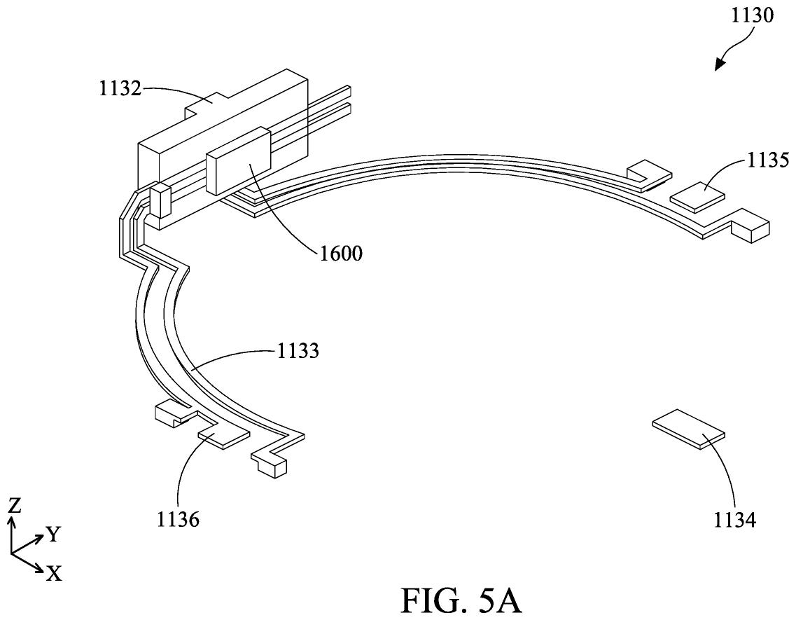

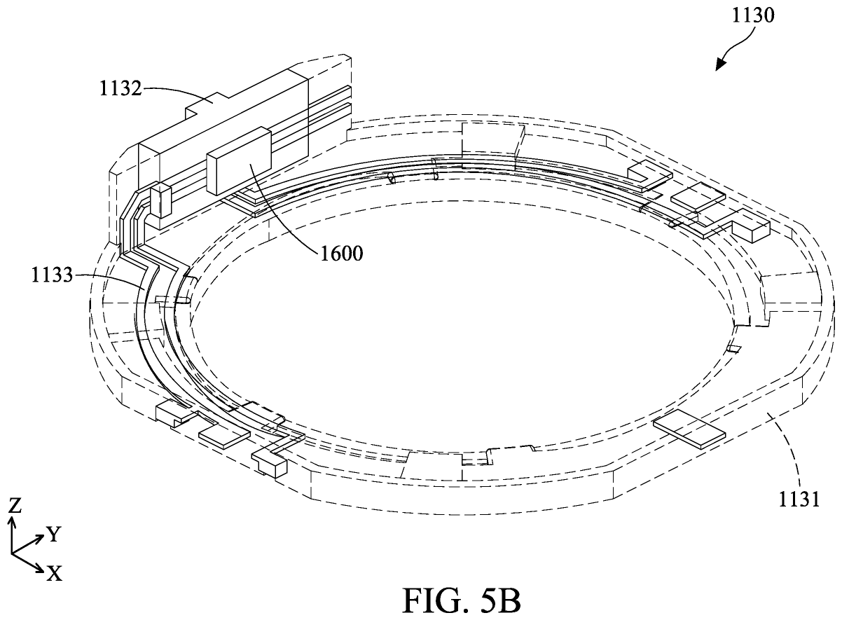

FIG. 5A and FIG. 5B show schematic diagrams of the manufacturing process of the base 1130 according to some embodiments of the present disclosure. In conventional techniques, a flexible printed circuit board (FPC) are often set as an individual component within an optical element driving mechanism. However, in the disclosed embodiments, the base 1130, which integrates control components (such as integrated circuit 1600 in FIG. 5A) and connecting elements 1133, replaces the conventional base and flexible printed circuit board. This reduces the number of parts and assembly stations, simplifying the process and saving manufacturing costs.

In some embodiments of the present disclosure, in the manufacturing process, first, the retaining wall 1132 and the plurality of connecting elements 1133 are combined together through injection molding. Next, the integrated circuit 1600 is mounted onto the retaining wall 1132. Then, the connecting element 1133 that has been combined with the retaining wall 1132 is formed into the shape shown in FIG. 5A through a bending process.

Next, the retaining wall 1132 and connecting element 1133 shown in FIG. 5A are put into a mold, and the body 1131 shown in FIG. 5B is formed through injection molding, thereby the base 1130 including the body 1131, the retaining wall 1132, the connecting element 1133 and the integrated circuit 1600 is integrated together.

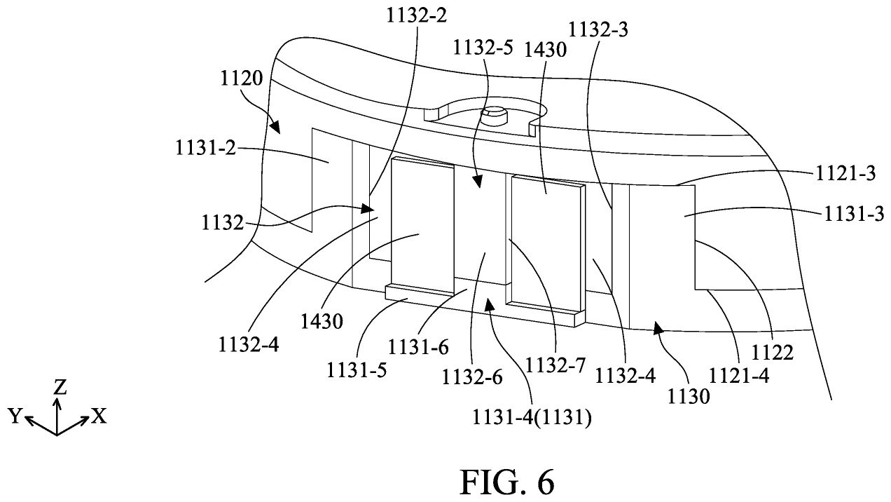

FIG. 6 shows a partial enlarged view of the optical element driving mechanism 1000 according to some embodiments of the present disclosure. As shown in FIG. 6, the body 1121 of the frame 1120 also includes a recessed surface 1121-3 and a lower surface 1121-4. When viewed toward the optical axis O along the direction perpendicular to the optical axis O (e.g., the direction of the X-axis), the recessed surface 1121-3 and the lower surface 1121-4 have different heights in the direction of the optical axis O. Thus, the accommodating space 1122 is formed between the recessed surface 1121-3 and the lower surface 1121-4 to accommodate the protruding columns 1131-2, 1131-3 and the retaining wall 1132 of the base 1130.

According to some embodiments of the present disclosure, the body 1131 of the base 1130 further includes a connecting structure 1131-4 in a protruding shape. The connecting structure 1131-4 is positioned between the protruding columns 1131-2 and 1131-3, and is positioned under the retaining wall 1132. The connecting structure 1131-4 includes a plate structure 1131-5 and a protruding portion 1131-6 extending from the middle of the plate structure 1131-5 along the direction of the Z-axis.

Since the protruding portion 1131-6 protrudes from the middle of the plate structure 1131-5, the protruding portion 1131-6 may generally divide the plate structure 1131-5 into two parts, left part and right part. Each of the magnetically permeable elements 1430 is disposed on opposite sides of the protruding portion 1131-6, contacting the protruding portion 1131-6 to position the two magnetically permeable elements 1430. Each of the magnetically permeable elements 1430 is disposed on the plate structures 1131-5 on opposite sides of the protruding portion 1131-6.

According to some embodiments of the present disclosure, the retaining wall 1132 includes a contact portion 1132-1 (FIG. 4), a pair of side surfaces 1132-2 and 1132-3, a pair of front surfaces 1132-4, and a protruding portion 1132-5.

Please temporarily refer to FIG. 4, the contact portion 1132-1 of the retaining wall 1132 is the surface of the retaining wall 1132 that is parallel to the optical axis O (FIG. 2) and faces the optical axis O. The integrated circuit 1600 and the coil 1410 are both disposed on the contact portion 1132-1 of the retaining wall 1132.

Please refer back to FIG. 6. The side surfaces 1132-2 and 1132-3 of the retaining wall 1132 are the two opposite surfaces of the retaining wall 1132. However, due to the obstruction of the protruding columns 1131-2 and 1131-3, only the edges of side surfaces 1132-2 and 1132-3 can be seen. The side surfaces 1132-2 and 1132-3 of the retaining wall 1132 are perpendicular to the contact portion 1132-1 (FIG. 4). The side surface 1132-2 of the retaining wall 1132 contacts the protruding portion 1131-2, the side surface 1132-3 of the retaining wall 1132 contacts the protruding portion 1131-3.

As shown in FIG. 6, the front surface 1132-4 of the retaining wall 1132 is the surface opposite the contact portion 1132-1 (FIG. 4). The front surface 1132-4 of the retaining wall 1132 is perpendicular to the side surfaces 1132-2 and 1132-3. The protruding portion 1132-5 protrudes from the middle of the two front surfaces 1132-4 in the direction away from the optical axis O (FIG. 2). The upper surface of the retaining wall 1132 is affixed to the recessed surface 1121-3 of the frame 1120.

According to some embodiments of the present disclosure, the protruding portion 1132-5 of the retaining wall 1132 includes a protruding surface 1132-6 and a pair of side surfaces 1132-7 on both sides thereof. The protruding surface 1132-6 of the protruding portion 1132-5 of the retaining wall 1132 is parallel to the front surface 1132-4 of the retaining wall 1132. The side surface 1132-7 of the protruding portion 1132-5 of the retaining wall 1132 is perpendicular to the protruding surface 1132-6.

According to some embodiments of the present disclosure, when viewed from the Z-axis, the protruding portion 1131-6 of the connecting structure 1131-4 of the base 1130 is aligned with the protruding portion 1132-5 of the retaining wall 1132. The two magnetically permeable elements 1430 are respectively abutted against the side of the protruding portion 1131-6 of the connecting structure 1131-4 and the side surface 1132-7 of the protruding portion 1132-5 of the retaining wall 1132.

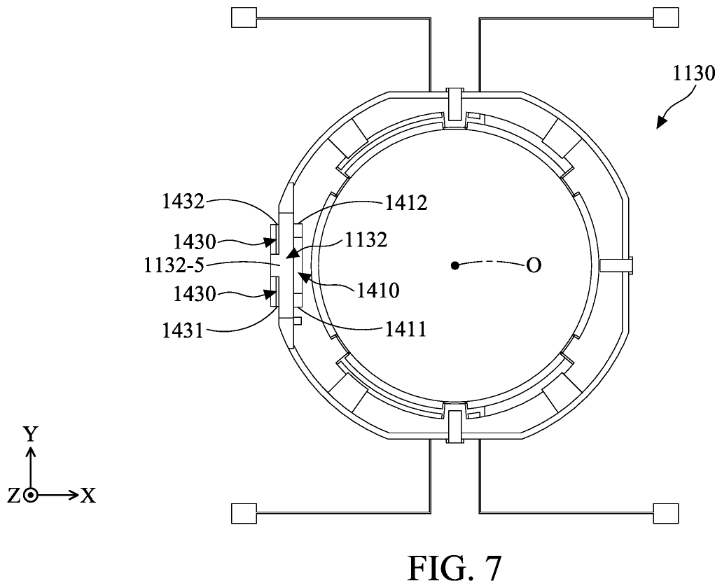

FIG. 7 shows a top view of the base 1130 and the coil 1410 according to some embodiments of the present disclosure. As shown in FIG. 7, the magnetically permeable element 1430 and the coil 1410 are respectively disposed on the outer sider (the side farther away from the optical axis O) and the inner side (the side closer to the optical axis O) of the retaining wall 1132.

According to some embodiments of the present disclosure, the coil 1410 includes a first edge 1411 and a second edge 1412 arranged along the Y-axis. The two magnetically permeable elements 1430 include a first edge 1431 and a second edge 1432 arranged along the Y-axis. When viewed along the Z-axis, the first edge 1411 of the coil 1410 is aligned with the first edge 1431 of the magnetically permeable element 1430 on the Y-axis. Similarly, when viewed along the Z-axis, the second edge 1412 of the coil 1410 is aligned with the second edge 1432 of the magnetically permeable element 1430 on the Y-axis.

In other words, when viewed from above the base 1130, the two ends of the magnetically permeable element 1430 and the two ends of the coil 1410 on the Y-axis are aligned. In this way, the two magnetically permeable elements 1430, which possess the effect of concentrated magnetic force, directly correspond to the two ends of the coil 1430 that can generate thrust to the movable portion 1200 (see FIG. 2).

Compared with the configuration using a single magnetically permeable element in the prior art, the present disclosure removes the material in the middle of the original single magnetically permeable element, thereby achieving a lightweight effect. For example, as seen in FIG. 7, the protruding portion 1132-5 of the retaining wall 1132 separates the two magnetically permeable elements 1430, rather than a single magnetically permeable element 1430 being disposed on the retaining wall 1132. In addition, the configuration of the protruding portion 1132-5 of the retaining wall 1132 may also make the positioning of the magnetically permeable element 1430 easier during the manufacturing process.

FIG. 8 shows a side view of the optical element driving mechanism 1000 according to some embodiments of the present disclosure. As shown in FIG. 8, the structural strengthening elements 1123 of the frame 1120 are partially exposed from the body 1121 of the frame 1120. The structural strengthening elements 1136 of the base 1130 are partially exposed from body 1131 of base 1130. In addition, when viewed along the direction of the Z-axis, the plurality of structural strengthening elements 1123 of the frame 1120 at least partially overlap with the structural strengthening elements 1134, 1135, and 1136 of the base 1130.

According to some embodiments of the present disclosure, the structural strengthening elements 1123 of the frame 1120 and the structural strengthening elements 1134 (FIG. 4), 1135 (FIG. 4), and 1136 (FIG. 8) of the base 1130 are welded through a high-temperature process. This achieves the effect of strengthening the connection strength between the frame 1120 and the base 1130.

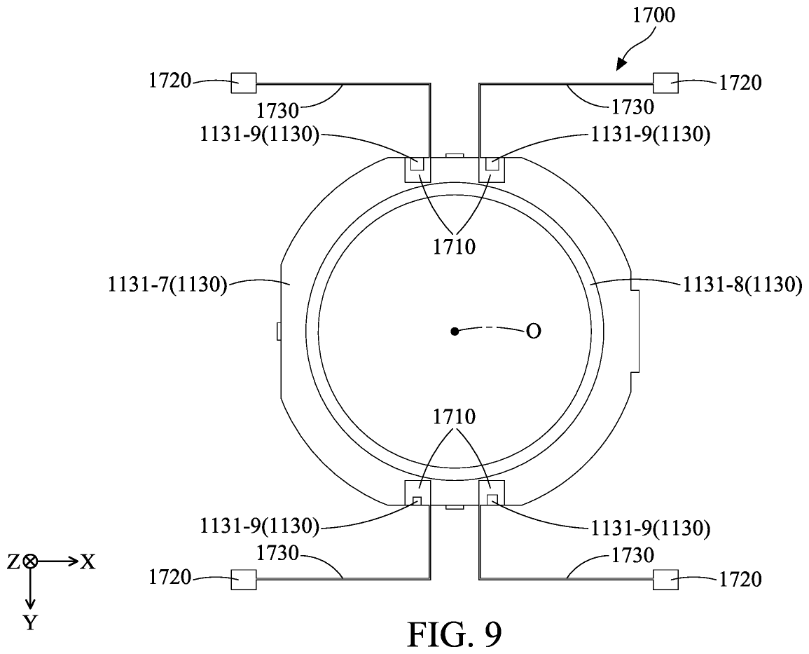

FIG. 9 shows a bottom view of the base 1130 and the elastic element 1700 according to some embodiments of the present disclosure. As shown in FIG. 9, the body 1131 of the base 1130 further includes a bottom surface 1131-7, a connecting portion 1131-8 and four welding portions 1131-9. Each of the four spring elements 1700 includes a fixed end 1710, a connecting end 1720 and an elastic portion 1730.

According to some embodiments of the present disclosure, the connecting portion 1131-8 of the base 1130 is an annular structure protruding downward (toward the direction of the negative Z-axis) from the bottom surface 1131-7 of the base 1130. The connecting portion 1131-8 of the base 1130 is configured to connect the optical element driving mechanism 1000 as the aperture mechanism to an optical module (not shown) carrying a lens module.

The optical module (not shown) carrying the lens module is located below the base 1130 of the optical element driving mechanism 1000 (that is, on the side closer to the bottom surface 1131-7 of the optical element driving mechanism 1000). That is to say, the incident light will first pass through the optical element driving mechanism 1000 and then pass through the optical module (not shown) below it.

According to some embodiments of the present disclosure, the welding portion 1131-9 of the base 1130 is a structure recessed from the bottom surface 1131-7 toward the Z direction. The welding portion 1131-9 of the base 1130 corresponds to the fixed end 1710 of the elastic element 1700. The fixed end 1710 of the elastic element 1700 is disposed on the bottom surface 1131-7 of the base 1130. The welding portion 1131-9 of the base 1130 and the fixed end 1710 of the elastic element 1700 are securely connected together by welding, thereby connecting the base 1130 and the elastic element 1700.

It should be understood that, although not shown, the end of the connecting element 1133 (FIG. 4) of the base 1130 at the body 1131 is exposed from the welding portion 1131-9 of the base 1130. Therefore, the integrated circuit 1600 (FIG. 4) and the coil 1410 (FIG. 4) can be electrically connected to the elastic element 1700 through the connecting element 1133 (FIG. 4), and then electrically connected to the optical module carrying the lens module (not shown) by the elastic element 1700.

According to some embodiments of the present disclosure, the connecting end 1720 of the elastic element 1700 is configured to be fixedly connected to a carrier (not shown) of the optical module (not shown) carrying the lens module. The elastic portion 1730 of the elastic element 1700 is made of elastic material. The two ends of the elastic portion 1730 of the elastic element 1700 are connected to the fixed end 1710 and the connecting end 1720.

In this way, the optical element driving mechanism 1000, serving as the aperture structure, exhibits greater impact resistance due to the elastic portion 1730 when moving together with the carrier (not shown) of the optical module (not shown) with features such as autofocus. That is to say, the optical element driving mechanism 1000, serving as the aperture structure, is less likely to detach or separate from the optical module (not shown) connected to it due to collisions.

As shown in FIG. 9, the distance between the connecting portion 1131-8 of the base 1130 and the optical axis O is smaller than the distance between the welding portion 1131-9 of the base 1130 and the optical axis O. The connecting portion 1131-8 of the base 1130 protrudes from the bottom surface 1131-7 of the base 1130 in the direction of the negative Z-axis. Therefore, when the optical element driving mechanism 1000 as the aperture mechanism collides with the optical module (not shown) carrying the lens module, the welding joint is less likely to be damaged by the impact, thereby extending the product lifespan.

It should be understood that in another embodiment, the connecting portion 1131-8 of the base 1130 may also be a structure that is recessed upward (toward the direction of the Z-axis) from the bottom surface 1131-7 of the base 1130. However, due to its different position along the Z-axis from the bottom surface 1131-7 of the base 1130, damage to the welding joint can still be avoided, achieving the effect of extending the product lifespan.

In summary, the present disclosure replaces the traditional separate components of flexible printed circuit boards and bases with an integrated base containing control components and conductive circuits. This reduces the number of parts and assembly stations, thus lowering manufacturing costs.

The specific relative positions and sizes of the disclosed components not only enable the optical element driving mechanism to achieve overall light weighting, but also strengthen the overall structure by means of welding joints between structural strengthening elements partially embedded within the frame and the base.

Although the embodiments and their advantages of the present invention have been disclosed above, it should be understood that any modification, substitution and modification can be made by anyone with ordinary skill in the art without departing from the spirit and scope of the present disclosure. In addition, each claimed patent scope constitutes an individual embodiment, and the protection scope of the present disclosure also includes the combination of each claimed patent scope and embodiments.

The above embodiments are described in sufficient detail to enable those skilled in the art to implement the devices disclosed in the present disclosure through the above descriptions. It should be understood that, without departing from the spirit and scope of the present disclosure, any modifications may be made without departing from the spirit and scope of the present disclosure. Minor modifications and refinements may be made, the scope of protection of this disclosure shall be determined by the appended patent scope.

What is claimed is:

1. An optical element driving mechanism, comprising:
a movable portion for connecting an optical element with an optical axis;
a fixed portion, the movable portion is movable relative to the fixed portion; and
a driving component is configured to drive the movable portion to move relative to the fixed portion.

2. The optical element driving mechanism as claimed in claim 1, wherein the fixed portion comprises a base, the base comprises a body, the body comprises an annular portion, and the structure of the annular portion is perpendicular to the optical axis.

3. The optical element driving mechanism as claimed in claim 2, wherein the body of the base further comprises a pair of protruding columns, the pair of protruding columns extend from the annular portion along a direction parallel to the optical axis on one side of the annular portion.

4. The optical element driving mechanism as claimed in claim 3, wherein the base further comprises a retaining wall, the retaining wall is parallel to the optical axis, and the retaining wall is located between the pair of protruding columns.

5. The optical element driving mechanism as claimed in claim 4, wherein the base further comprises a connecting element, the connecting element is partially embedded in the annular portion, the retaining wall and the pair of protruding columns.

6. The optical element driving mechanism as claimed in claim 4, wherein the retaining wall of the base comprises a contact portion and a pair of front surfaces, the contact portion is a surface of the retaining wall that is facing the optical axis, and the pair of front surfaces are surfaces of the retaining wall that are facing away from the optical axis.

7. The optical element driving mechanism as claimed in claim 6, wherein the retaining wall of the base further comprises a protruding portion, and the protruding portion protrudes from between the pair of front surfaces in a direction away from the optical axis.

8. The optical element driving mechanism as claimed in claim 7, wherein the driving component comprises a coil disposed on the contact portion of the retaining wall.

9. The optical element driving mechanism as claimed in claim 7, wherein the driving component comprises two magnetically permeable elements disposed on the pair of front surfaces of the retaining wall, and the magnetically permeable elements contact opposite sides of the protruding portion to position the magnetically permeable elements.

10. The optical element driving mechanism as claimed in claim 4, wherein the fixed portion further comprises a frame, the frame comprises a recessed surface and a lower surface, and the recessed surface and the lower surface are planes of the frame that are perpendicular to the optical axis.

11. The optical element driving mechanism as claimed in claim 10, wherein the recessed surface and the lower surface of the frame have different heights on the optical axis.

12. The optical element driving mechanism as claimed in claim 10, wherein the frame further comprises an accommodating space, and the accommodating space for accommodating the retaining wall and the pair of protruding columns is formed between the recessed surface and the lower surface.

13. The optical element driving mechanism as claimed in claim 10, wherein an upper surface of the retaining wall is affixed to the recessed surface of the frame to fix the retaining wall.

14. The optical element driving mechanism as claimed in claim 1, wherein the fixed portion comprising a base, the base comprises a bottom surface and a welding portion, and the welding portion of the base is a structure recessed from the bottom surface in a direction parallel to the optical axis.

15. The optical element driving mechanism as claimed in claim 14, further comprising an elastic element, the elastic element comprises a fixed end, wherein the welding portion of the base corresponds to the fixed end of the elastic element, the fixed end of the elastic element is provided on the bottom surface of the base, and the welding portion of the base and the fixed end of the elastic element are fixedly connected the base and the elastic element together via welding.

16. The optical element driving mechanism as claimed in claim 15, wherein the elastic element further comprises a connecting end, and the connecting end of the elastic element is configured to fixedly connect to an optical module.

17. The optical element driving mechanism as claimed in claim 16, wherein the elastic element further comprises an elastic portion, the elastic portion of the elastic element is made of elastic material, and two ends of the elastic portion are connected to the fixed end and the connecting end.

18. The optical element driving mechanism as claimed in claim 16, wherein the base further comprises a connecting portion protruding from the bottom surface of the base along a direction of the optical axis, and the connecting portion of the base is connected to the optical module under the optical element driving mechanism.

19. The optical element driving mechanism as claimed in claim 1, further comprising a plurality of supporting elements, the fixed portion comprises a groove, two of the supporting elements are disposed in the groove of the fixed portion along a direction parallel to the optical axis, and the supporting elements contact the movable portion to provide support for the movement of the movable portion relative to the fixed portion.

20. The optical element driving mechanism as claimed in claim 1, wherein the fixed portion comprises a frame and a base, the frame comprises a body and a structural strengthening element, the structural strengthening element of the frame is partially embedded in the body of the frame, the base comprises a body and a structural strengthening element, the structural strengthening element of the base is partially embedded in the body of the base, the structural strengthening element of the frame and the structural strengthening element of the base are joined by welding to securely connect the frame and the base together.
